(19) United States
(12) Patent Application Publication
(10) Pub. No.: US 2026/0293946 A1
(43) Pub. Date: Oct. 1, 2026

(54) FOOD PRODUCT

(71) Applicant: Joseph Ernest BELOTT, JR., New Providence, NJ (US)

(72) Inventors: Joseph Ernest Belott, JR., New Providence, NJ (US); Mark Mattheiss, West Caldwell, NJ (US)

(73) Assignee: Joseph Ernest BELOTT, JR., New Providence, NJ (US)

(21) Appl. No.: 19/707,200

(22) Filed: Jun. 12, 2026

Related U.S. Application Data
(63) Continuation-in-part of application No. 19/252,807, filed on Jun. 27, 2025.
(60) Provisional application No. 63/666,288, filed on Jul. 1, 2024.

(51) Int. Cl. A23L 13/60; A23L 5/10; A23P 20/20

(52) U.S. Cl. CPC A23L 13/62; A23L 5/11; A23P 20/20

(57) ABSTRACT

A food product includes a plurality of meatballs and separators made of sauce located in an outer casing. Each of the separators is located between adjacent meatballs and with each separator having concavities for engaging the substantially spherically shaped meatballs. A method for making the food product is also described. The food product facilitates eating a meatball sandwich without the typically associated mess that occurs when each meatball sandwiches.

### CROSS REFERENCE TO RELATED APPLICATIONS

This application is a continuation-in-part of prior-filed U.S. patent application Ser. No. 19/252,807, filed Jun. 27, 2025, which claims the benefit of priority from U.S. Provisional Patent Application No. 63/666,288, filed Jul. 1, 2024; the disclosures of all of which are incorporated herein by reference in their entirety.

### FIELD OF THE DISCLOSURE

The present disclosure relates generally to a food product, and more particularly, to a food product comprising meatballs.

### BACKGROUND

Meatball sandwiches are a popular food item but suffer from the fact that they are messy and inconvenient to eat. This is particularly true when a sauce, condiment, and/or or topping is added to the sandwich. This makes meatball sandwiches difficult to eat at public events such as sporting events and the like.

### SUMMARY

A food product includes an outer casing, a plurality of meatballs located in the outer casing, a separator comprising sauce located between each pair of the plurality of meatballs and each separator is substantially flat on each side and each of the plurality of meatballs is substantially flat on a side adjacent to a separator. Each separator can be substantially cylindrical and be approximately one inch in diameter and half inch in width and formed of sauce in a casing. In one embodiment, the sauce in each separator is dehydrated. The food product can be deep fried and include meatballs each weighing approximately half an ounce to one ounce. In a preferred embodiment, the meatballs each weighing approximately seven tenths of an ounce (0.7 ounce). In one embodiment, the plurality of meatballs includes 4 meatballs. Each of the meatballs can be precooked for 10 minutes at 325 degrees Fahrenheit or until its internal temperature is 155 degrees Fahrenheit. The outer casing can be a hog casing having a diameter of approximately 36-38 millimeters. In one embodiment, the outer casing has a plurality of openings for air and/or steam to escape from inside the outer casing.

A method includes inserting a plurality of meatballs into a tube and inserting a separator between each adjacent pair of the plurality of meatballs during the inserting the plurality of meatballs into the tube. The separator can be made of dehydrated sauce. The tube is inserted into an outer casing and the plurality of meatballs are pushed out of the tube and into the outer casing. The tube is then removed from the outer casing. In one embodiment, each separator is substantially flat on each side and each of the plurality of meatballs is substantially flat on a side adjacent to a separator. In one embodiment, the outer case is sealed. The sauce of each separator can be frozen. The outer casing can expand and expands when the tube is inserted into the outer casing. In one embodiment, each separator is substantially cylindrical and is approximately 1 inch in diameter and one half inch in width. In one embodiment, a condiment casing is inserted into the tube. In one embodiment, the pushing the plurality of meatballs out of the tube and into the outer casing includes pushing the condiment casing out of the tube and into the outer casing. In one embodiment, the outer casing and its contents are deep fried. A food product made using the method described above is also described herein.

### BRIEF DESCRIPTION OF THE DRAWINGS

FIG. 1 shows a food product according to one embodiment;

FIG. 2 shows a food product according to another embodiment;

FIG. 3 shows dimensions of a food product according to one embodiment;

FIG. 4 shows a tube for inserting ingredients into a casing according to one embodiment;

FIG. 5 shows a flow chart of a method according to one embodiment;

FIG. 6 shows a tube holding ingredients according to one embodiment;

FIG. 7 shows the tube holding ingredients partially inserted into a casing according to one embodiment;

FIG. 8 shows tube being removed from casing according to one embodiment;

FIG. 9 shows a food product sealed in a casing according to one embodiment; and

FIG. 10 shows a food product according to one embodiment.

### DETAILED DESCRIPTION

In accordance with the present disclosure, a food product is provided in which meatballs (and optionally sauce and/or other condiments) are encased in a casing thereby making it easier to consume without the mess. The casing (e.g., a food grade casing) can be made of natural or synthetic materials.

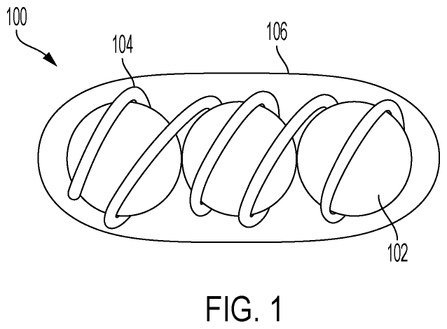

FIG. 1 shows food product 100 in accordance with one embodiment of the present disclosure. Food product 100 comprises one or more meatballs 102. In FIG. 1, three meatballs are shown but any number of meatballs may be used. Each meatball 102 may comprise any type of meat (or meat substitute) formed into a generally spherical shape. For example, the meatballs 102 could comprise beef, pork, chicken, or any other type of meat. The meatball could comprise a meat substitute. The meatball could be any combination of meat and/or meat substitutes. The meatball could additionally include any other well-known ingredients used to make a meatball. Any well-known type of meatballs (whether containing meat or otherwise) may be used in conjunction with the present food product. In various embodiments, meatballs are precooked before placement in the outer casing of the food product. In one embodiment, each meatball is approximately 0.5 (one-half) to 1 (one) ounce and preferably seven-tenths of an ounce (i.e., 0.7 ounce). In one embodiment, each meatball is cooked at 300-400 degrees Fahrenheit for 6-12 minutes. In one embodiment each meatball is cooked until the internal temperature of the meatball is approximately 155 to 165 degrees Fahrenheit. In a preferred embodiment, each meatball is cooked (e.g., baked) at 325 degrees Fahrenheit for 10 minutes or until the internal temperature reaches 155 degrees Fahrenheit.

In one embodiment, the meatballs are encircled or surrounded by a generally hollow condiment casing 104. The condiment casing 104 can be made from any type of casing (e.g., food grade casing). The condiment casing 104 encloses and contains within the hollow portion thereof any type of sauce, topping or condiment such as, without limitation, tomato sauce, ketchup, mustard, barbeque sauce, cheese, mayonnaise, relish, or any combination thereof. In one embodiment the condiment casing 104 disintegrates or melts when cooked or exposed to heat. In other embodiments, there can be multiple condiment casings with each holding a different sauce, topping, or condiment, or combination thereof.

The meatballs 102 and the condiment casing 104 are completely enclosed within an outer casing 106. The outer casing 106 can be made from any type of material suitable for containing ingredients therein (e.g., a food grade casing). Unlike condiment casing 104, outer casing 106 does not disintegrate or melt when cooked or exposed to heat. In one embodiment, the outer casing is a 36-38 millimeter diameter hog casing but can be other types and sizes of casings as well. In one embodiment, the diameter of outer casing 106 is the diameter when filled with ingredients (e.g., meatballs and separators). In one embodiment, the outer casing is pricked using one or more pointed rods to generate a plurality of openings for air and/or steam to escape. For example, a plurality of tines on a fork-like object can be used to generate the plurality of openings.

When cooked or heated, the condiment casing 104 disintegrates or melts, thereby allowing an outflow of the contents from the hollow portion of the condiment casing 104. Since the outer casing 106 does not disintegrate or melt the contents of condiment casing 104 remain held within the outer casing 106 along with the meatballs 102. The contents of the condiment casing thus get distributed among the meatballs 102 but remain within outer casing 106. Thus, when cooked or heated, the meatball food product 100 can be consumed more neatly and orderly as compared to a standard meatball sandwich.

In an alternate embodiment, the condiment casing 104 does not disintegrate or melt when heated or cooked and instead is made from the same or similar type of casing as outer casing 106.

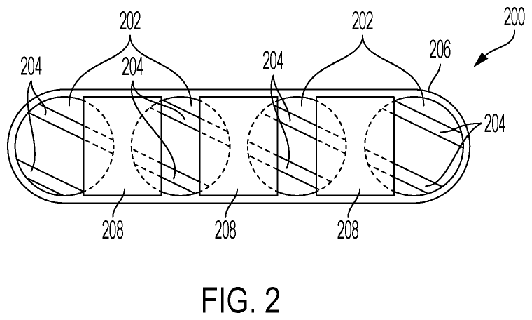

FIG. 2 shows a food product 200 according to one embodiment having a substantially tubular shape. Food product 200 comprises one or more meatballs 202 (similar to meatballs 102 described above') located within outer casing 206 and spaced apart by separators 208 located between each adjacent pair of meatballs. It should be noted that the phrase adjacent pair of meatballs as used herein refers to a pair of meatballs that are directly adjacent to one another. For example, if there are three meatballs in a food product, the meatballs located at each end are both directly adjacent to the center meatball. Thus, a food product with three meatballs is considered to comprise two pairs of meatballs—one pair comprising the center meatball and the meatball on one end and the other pair comprising the center meatball and the meatball on the opposite end. It should also be noted that the phrase meatball and separator adjacent pair as used herein refers to a meatball and a separator that is located directly adjacent to the meatball. Thus, a single meatball located between two separators forms a pair with each separator.

Although food product 200 is shown having four meatballs and three separators, any number of meatballs and respective separators can be used as well. For example, in one embodiment, each end of food product 200 can also have a separator. In such embodiments, the food product would have separators located between each adjacent pair of meatballs as well as a separator located at each end of food product 200 so that the separators on each end are located adjacent to each of the meatballs located furthest from the longitudinal center of food product 200. Meatballs 202 are shown having a substantially spherical shape but can be other shapes as well. In one embodiment, each adjacent pair comprising a separator and a meatball have complimentary surfaces that allow the meatball and separator to mate (e.g., engage or contact) each other. In one embodiment, a meatball can be a substantially cylindrical shape with each end having a convex surface configured to engage, contact, or mate with a surface of an adjacent separator. In one embodiment, separators 208 are biconcave discs having a substantially cylindrical shape with each end of the cylinder having a concavity substantially sized and shaped to mate with a portion of the surface of adjacent meatballs as shown in FIG. 2. In other embodiments, differently shaped separators can be used as well (e.g., cube, cylinder, etc.). Any shape of meatball and separator may be used such that the meatball and corresponding separator have complimentary surfaces where meatballs and separators mate or contact each other. In various embodiments, separators are cylindrical or disc-shaped (i.e., coin-shaped) with generally flat sides. In various embodiments, meatballs adjacent to one or two separators can have one or both sides being substantially flat to engage with the respective flat surface of each adjacent separator (i.e., a flat side of a meatball mates with a flat side of each adjacent separator). In one embodiment, separators are cylindrical and approximately one inch in diameter and one half inch in width. In one embodiment, separators 208 are each made of a red sauce, such as a tomato sauce traditionally served with a dish such as spaghetti and meatballs. Separators 208 can be made of different sauces, condiments, toppings, or liquids having different consistencies. In one embodiment, the sauce used to form the separators is dehydrated to a desired moisture content so as to result in a desired consistency. In one embodiment, the sauce is dehydrated to prevent excess steam development within outer casing 206. In one embodiment, the sauce is dehydrated by heating the sauce until it loses a desired percentage of weight due to evaporation of water from the sauce. In one embodiment, the sauce is dehydrated by heating at 150-175 degrees Fahrenheit until the sauce is approximately 70-98 percent of its original weight. Separators 208 help outer casing 206 maintain its tubular shape. As food product 200 is heated prior to consumption, separators 208 become heated and the liquid of separator 208 flows over adjacent meatballs while substantially maintaining its own shape as well as the tubular shape of outer casing 206. Depending on the consistency of the ingredients used to form separators 208, the ingredients may be cooled or frozen (e.g., a frozen liquid) in order to facilitate placement in outer casing 206. In one embodiment, separators 208 are each formed using a casing (not shown) encasing the ingredients of the separator. The casing forming the separator can be made of material that disintegrates when heated or maintains its properties when heated. The casing forming each separator facilitates the separators maintaining their shape before, during, and after cooking of food product 200. Food product 200, in one embodiment, has condiment casing 204 containing additional sauce or a condiment. The construction of condiment casing 204 is similar to the construction of condiment casing 104 described above in connection with FIG. 1.

Food products 100 and 200 can be distributed freshly made or frozen and can be heated (e.g., cooked) in any manner in which food is typically heated before serving. Food products 100 and 200 may be distributed uncooked or fully cooked. In one embodiment, food products 100 and 200 (i.e., the outer casing and its contents) can be baked, broiled, grilled, and/or deep fried.

In one embodiment, when food product 100 (shown in FIG. 1) is heated, meatballs 102 become hot and condiment casing 104 melts as its contents (e.g., sauce) are heated. The contents of the condiment casing flow over meatballs 102 after condiment casing 104 melts. In another embodiment, the condiment casing 104 does not melt when its contents are heated. Whether or not condiment casing 104 melts, meatballs 102 and the content of condiment casing 104 are contained in outer casing 106 thereby preventing a mess. In addition, an end of food product 100 can be bitten through by a person consuming food product 100 and outer casing 106 holds the remaining portion of food product 100 in a generally tubular shape.

In one embodiment, when food product 200 (Shown in FIG. 2) is heated, meatballs 202 become hot and condiment casing 204 melts as its contents (e.g., sauce) are heated. The contents of the condiment casing flow over meatballs 202 after condiment casing 204 melts. In another embodiment, the condiment casing 204 does not melt when its contents are heated. Whether or not condiment casing 204 melts, meatballs 202 and the content of condiment casing 204 are contained in outer casing 206 thereby preventing a mess. Separators 208 become heated and the contents of separators 208 flow over meatballs 202 while maintaining the tubular shape of outer casing 206. In embodiments where separators 208 are contained in a casing, the casing may or may not melt but in either case, the contents of separators 208 help outer casing 206 maintain its tubular shape. In addition, an end of food product 200 can be bitten through by a person consuming food product 200 and outer casing 206 holds the remaining portion of food product 200 in a generally tubular shape.

Food products 100 and 200 as described above, can be eaten without the typical mess associated with foods, such as meatball sandwiches, that occurs when those types of foods are eaten. The heated food product can be placed on bread such as a roll (e.g., a hot dog roll) for consumption. The heated food product can also be eaten alone in a manner similar to how other types of foods are consumed such as on a plate alone or with other foods. In one embodiment, the food product can be held by a person in a holder that allows the person to eat the food product alone.

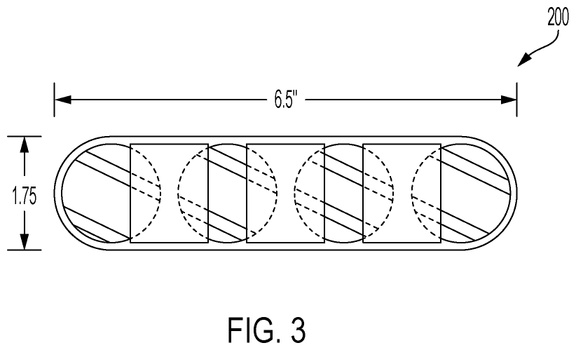

FIG. 3 shows food product 200 having a length of approximately 6.5 inches and a width of approximately 1.75 inches but can be other dimensions as well. For example, food product 200 could be 7 inches long and 1.5 inches wide or other sizes depending on the desired size and number of meatballs and separators. The amount of ingredients in the outer casing of a food product determines the size of the food product. The number of meatballs and separators, as well as the size of the meatballs and separators, can be varied to produce a desired size of food product 200. For example, food product 200 can be made to be approximately the same size as a hot dog and eaten with a hot bog bun. Food product 200 can be made larger to fit on a larger roll such as a “submarine sandwich” or “grinder” roll. In one embodiment, meatballs can be separated by two or more separators located between pairs of adjacent meatballs.

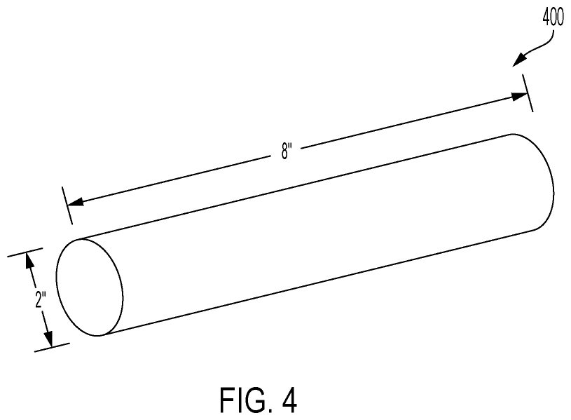

In one embodiment, food product 200 is made using a tube that is filled with ingredients (e.g., contents of the tube) and then inserted into an outer casing before the ingredients are pushed out of the tube and into outer casing 206. In one embodiment, the inside dimension of the outer casing is smaller than the corresponding tube, but the outer casing can expand (e.g., stretch) to accommodate the tube. FIG. 4 shows tube 400 that is used to fill a casing with ingredients. In one embodiment, tube 400 is approximately 8 inches in length and approximately 2 inches in diameter. Tube 400 can be made of glass, stainless steel, or any other material that can hold food and be used to insert food into a casing. Tube 400 can be sized to accommodate different sizes of ingredients. In one embodiment, tube 400 is sized based on the size of meatballs and separators to be inserted into an outer casing.

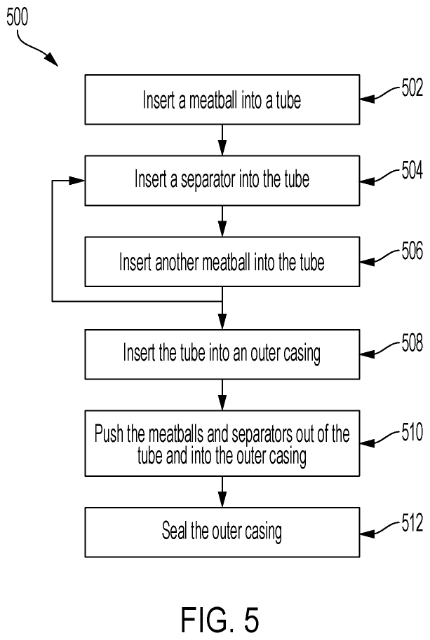

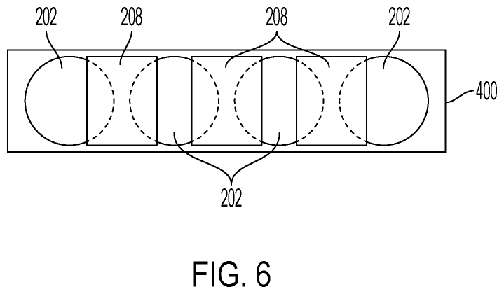

FIG. 5 shows a flowchart of a method for making food product 200 which will be described in connection with FIGS. 6-9. At step 502, a meatball is inserted into a tube. At step 504, a separator is inserted into the tube. At step 506, another meatball is inserted into the tube. As shown in FIG. 5, insertion of an additional separators and meatballs can be repeated as shown by the arrow starting downstream of step 506 and pointing to step 504 depending on how many additional meatballs and separators are to be put into an outer casing. In one embodiment, the number of meatballs is equal to the number of separators plus one. For example, FIG. 6 shows multiple meatballs 202 located adjacent to multiple separators 208, specifically, four meatballs separated by three separators. More or less number of meatballs and separators can be used as well. It should be noted that a condiment casing can be inserted into tube 400 as well but is not shown in FIG. 6 for clarity.

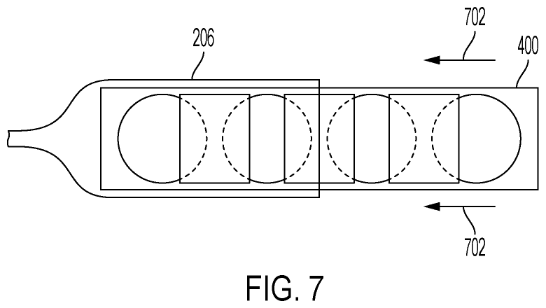

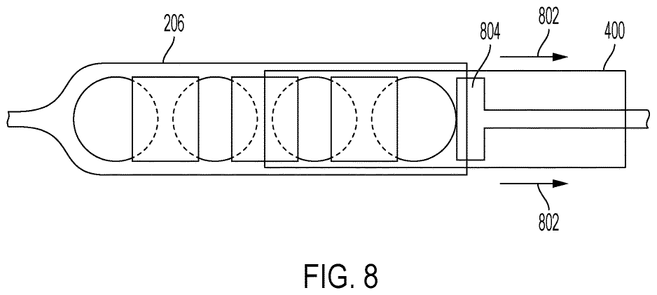

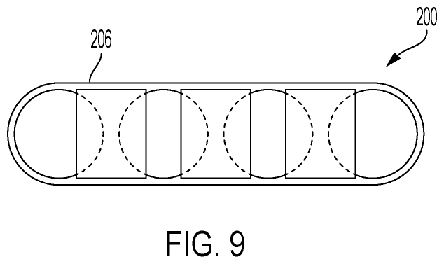

At step 508, tube 400 is shown in FIG. 7 holding four meatballs separated by three separators, being pushed into an outer casing in the direction of arrows 702. At step 510, the meatballs and separators are pushed out of the tube and into the outer casing as shown in FIG. 8. In one embodiment, the meatballs and separators are pushed out of tube 400 into outer casing 206 by plunger 804 (mechanical, manual, and/or automated) but can be pushed using other methods such as pneumatic or hydraulic or a combination of those techniques. Further, the description herein pertains to the relative motion of the ingredients, tube, and casing and the actual objects being moved with respect to each other can vary. At step 512, the tube is removed from the outer casing and FIG. 9 shows food product 200 after the ends of outer casing 206 have been sealed at step 514. In one embodiment, the ends of outer casing are twisted to seal the meatballs and separators inside outer casing 206 but other methods, such as heat sealing or crimping can be used as well.

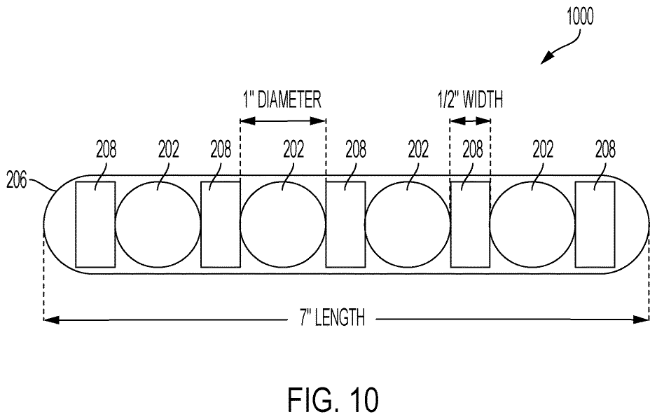

FIG. 10 shows food product 1000 according to one embodiment. As shown in FIG. 10, four meatballs 202, each having a diameter of approximately one (1) inch, are separated by three separators 208, each having a width of approximately one-half (½) inch. In addition, a separator 208 is located at each end of food product 1000. As shown in FIG. 10, all of meatballs 202 and separators 208 are located in outer casing 206. In this embodiment, food product 1000 has a length of approximately seven (7) inches.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A food product comprising:
an outer casing;
a plurality of meatballs located in the outer casing; and
a separator located between each pair of the plurality of meatballs, the separator comprising sauce,
wherein each separator is substantially flat on each side and each of the plurality of meatballs is substantially flat on a side adjacent to a separator.

2. The food product of claim 1, wherein each separator is substantially cylindrical.

3. The food product of claim 1, wherein each separator is approximately one inch in diameter and one half inch in width.

4. The food product of claim 1, wherein the food product is deep fried.

5. The food product of claim 1, wherein each meatball approximately weighs between half an ounce and one ounce.

6. The food product of claim 1, wherein the plurality of meatballs comprises four meatballs.

7. The food product of claim 1, wherein each of the meatballs is precooked for 10 minutes at 325 degrees Fahrenheit or until its internal temperature is 155 degrees Fahrenheit.

8. The food product of claim 1, wherein the outer casing is a hog casing.

9. The food product of claim 1, wherein the outer casing has a diameter of approximately 36-38 millimeters.

10. The food product of claim 1, wherein the outer casing has a plurality of openings for air and/or steam to escape from inside the outer casing.

11. The food product of claim 1, wherein the sauce in each separator is dehydrated.

12. A method comprising:
inserting a plurality of meatballs into a tube;
inserting a separator between each adjacent pair of the plurality of meatballs during the inserting the plurality of meatballs into the tube, the separator comprising sauce;
inserting the tube into an outer casing;
pushing the plurality of meatballs out of the tube and into the outer casing; and
removing the tube from the outer casing,
wherein each separator is substantially flat on each side and each of the plurality of meatballs is substantially flat on a side adjacent to a separator.

13. The method of claim 12, further comprising:
sealing the outer casing.

14. The method of claim 13, wherein the sauce in each separator is dehydrated.

15. The method of claim 12, wherein the outer casing is expandable and expands when the tube is inserted into the outer casing.

16. The method of claim 12, wherein each separator is substantially cylindrical.

17. The method of claim 16, wherein each separator is approximately one inch in diameter and one half inch in width.

18. The method of claim 12, further comprising:
inserting a condiment casing into the tube,
wherein the pushing the plurality of meatballs out of the tube and into the outer casing includes pushing the condiment casing out of the tube and into the outer casing.

19. The method of claim 12, further comprising deep frying the outer casing and its contents.

20. A food product made using the method of claim 12.
